(19) United States
(12) Patent Application Publication
(10) Pub. No.: US 2020/0032375 A1
(43) Pub. Date: Jan. 30, 2020

(54) ALUMINUM ALLOY MATERIAL, METHOD FOR PRODUCING ALUMINUM ALLOY MATERIAL, BASKET FOR CASK, AND CASK

(71) Applicant: MITSUBISHI HEAVY INDUSTRIES, LTD., Tokyo (JP)

(72) Inventor: Takaharu Maeguchi, Tokyo (JP)

(73) Assignee: MITSUBISHI HEAVY INDUSTRIES, LTD., Tokyo (JP)

(21) Appl. No.: 16/519,539

(22) Filed: Jul. 23, 2019

(30) Foreign Application Priority Data
Jul. 26, 2018 (JP) 2018-139960

(51) Int. Cl. C22C 21/00; C22F 1/04; C22C 1/04; B22F 9/04; G21F 5/008

(52) U.S. Cl. CPC C22C 21/00; C22F 1/04; C22C 1/0416; B22F 2301/052; G21F 5/008; B22F 2009/041; B22F 9/04

(57) ABSTRACT

An aluminum alloy material according to an embodiment is based on aluminum and contains 2.5 mass % or more and 4.0 mass % or less of manganese, 0.01 mass % or more and 0.12 mass % or less of zirconium, and 0.55 mass % or more and 0.60 mass % or less of iron.

### TECHNICAL FIELD

The present disclosure relates to an aluminum alloy material, a method for producing an aluminum alloy material, a basket for a cask, and a cask.

### BACKGROUND ART

A manganese-containing aluminum alloy, which is excellent in thermal stability, is often used as the material of a member used in a high-temperature environment for a long period of time.

For instance, a metal cask for transporting or storing spent fuel stores spent fuel for a long period (e.g., 60 years) therein and then transports it to a reprocessing facility or the like. That is, the metal cask and a structural member thereof are exposed to decay heat of spent fuel (heating element) over a long period of storing the spent fuel. Non-Patent Document 1 discloses using a manganese-containing aluminum alloy as the material of a structural member (e.g., basket) of the metal cask.

Further, Patent Document 1 discloses producing a material characteristic evaluation sample simulating a heat degradation phenomenon such as coarse precipitation which can occur in an actual product depending on thermal history, in order to evaluate strength characteristics and other properties of an aluminum alloy material including a manganese-containing aluminum alloy.

### CITATION LIST

### Patent Literature

Patent Document 1: JP5960335B

### Non-Patent Literature

Non-Patent Document 1: Japan Society of Mechanical Engineers, “Codes for construction of spent nuclear fuel storage facilities—Rules on transport/storage packagings for spent nuclear fuel—(2007)”, published on February, 2008

### SUMMARY

A manganese-containing aluminum alloy (e.g., 3000 series aluminum alloys) is excellent in thermal stability but is inferior in strength characteristics, compared to other aluminum alloys (e.g., 2000 series aluminum alloys containing durahlumin). For this reason, the manganese-containing aluminum alloy has been hardly used as a strength member, and there has been little need for improvement in strength characteristics of the manganese-containing aluminum alloy.

However, it is desired to improve strength characteristics such as high-temperature strength of the manganese-containing aluminum alloy excellent in thermal stability to improve storage density of the above-described metal cask or to deal with higher burnup fuels.

In view of the above, an object of at least one embodiment of the present invention is to provide an aluminum alloy material with improved strength characteristics.

(1) An aluminum alloy material according to at least one embodiment of the present invention is based on aluminum and comprises: 2.5 mass % or more and 4.0 mass % or less of manganese; 0.01 mass % or more and 0.12 mass % or less of zirconium; and 0.55 mass % or more and 0.60 mass % or less of iron.

In the aluminum alloy, manganese is a metallic element which contributes to precipitation strengthening. That is, manganese is crystallized or precipitated as an Al—Mn compound and forms precipitates, thereby improving strength characteristics of the aluminum alloy material. The maximum solubility limit of manganese in aluminum is 1.82 mass % at 658.5° C. (eutectic temperature), and manganese usually does not enter into solid solution in the aluminum alloy containing 1.82 mass % or more of manganese at the eutectic temperature or lower. Thus, such an aluminum alloy does not form a precipitate which contributes to improvement in strength characteristics but forms a eutectic structure of aluminum (Al) and Al₆Mn which does not substantially contribute to improvement in strength characteristics. Accordingly, it is generally considered that it is difficult to improve strength characteristics in the aluminum alloy containing more than 1.82% of manganese.

However, by rapidly cooling the melt of the aluminum alloy containing more than the maximum solubility limit of manganese as in the above (1), it is possible to obtain a supersaturated solid solution in which the manganese enters into solid solution in aluminum in a supersaturated manner. Further, by subjecting the supersaturated solid solution to heat treatment, it is possible to precipitate Mn-based dispersed phase, specifically, fine particles of Al₆Mn or the like. Consequently, more manganese can be precipitated as fine particles of Al₆Mn or the like in aluminum than usual. Thus, it is possible to obtain the aluminum alloy material with improved strength characteristics.

Further, with the above configuration (1), since the contained zirconium prevents generation of coarse particles in the aluminum alloy, it is possible to prevent a reduction in strength of the aluminum alloy.

Further, with the above configuration (1), it is possible to precipitate fine particles of Al₆Mn or the like in solid Al using Fe as precipitate nuclei at the eutectic temperature or lower in the aluminum alloy containing more than the maximum solubility limit of manganese. Consequently, more manganese can be precipitated as fine particles of Al₆Mn or the like in aluminum than usual. Thus, it is possible to obtain the aluminum alloy material containing manganese in an amount equal to or more than the maximum solubility limit, with improved strength characteristics.

(2) In some embodiments, in the above configuration (1), the aluminum alloy material further comprises 0.06 mass % or more and 0.10 mass % or less of silicon.

With the above configuration (2), it is possible to precipitate fine particles of Al₆Mn in solid Al using Si as precipitate nuclei at the eutectic temperature or lower in the aluminum alloy containing more than the maximum solubility limit of manganese. Consequently, more manganese can be precipitated as fine particles of Al₆Mn in aluminum than usual. Thus, it is possible to obtain the aluminum alloy material with improved strength characteristics.

(3) In some embodiments, in the above configuration (1) or (2), the aluminum alloy material further comprises 0.8 mass % or more and 1.3 mass % or less of magnesium.

With the above configuration (3), the magnesium enters into solid solution in aluminum in the aluminum alloy, and it is possible to improve the strength of the aluminium alloy.

(4) A method for producing an aluminum alloy material according to at least one embodiment of the present invention comprises: a cooling step of supplying a melt of an aluminum alloy based on aluminum (Al) and containing 2.5 mass % or more and 4.0 mass % or less of manganese (Mn) with a high-pressure gas to cool and atomize the melt so that the manganese enters into solid solution in an aluminum parent phase in a supersaturated manner to obtain a powdered supersaturated solid solution; a step of performing mechanical alloying process on the powdered supersaturated solid solution; and a heat treatment step of performing heat treatment on the powdered supersaturated solid solution subjected to the mechanical alloying process to precipitate at least a part of the manganese as Al₆Mn and obtain an aluminum alloy material.

In the above producing method (4), since the melt of the aluminum alloy containing manganese is atomized and rapidly cooled simultaneously by supplying the melt with a high-pressure gas, it is possible to form the supersaturated solid solution in which the manganese enters into solid solution in the aluminum parent phase in a supersaturated manner. Further, by performing mechanical alloying process on the supersaturated solid solution thus obtained, it is possible to further disperse the manganese in the solid solution. Further, by performing heat treatment on the powdered supersaturated solid solution subjected to mechanical alloying process, it is possible to precipitate at least a part of the manganese dissolved in the aluminum in the supersaturated solid solution as more dispersed and finer Al₆Mn particles. Therefore, it is possible to obtain the aluminum alloy material with further improved strength characteristics, compared to the case where mechanical alloying process is not performed.

(5) In some embodiments, in the above method (4), in the step of performing mechanical alloying process, the mechanical alloying process is performed so that 70% or more and 90% or less of the number of particles of the powdered supersaturated solid solution subjected to the mechanical alloying process form multilayers.

As a result of intensive studies by the present inventor, it has been found that, as the proportion of multi-layered particles formed by mechanical alloying process increases in particles of the powdered supersaturated solid solution, the strength of the aluminum alloy material increases. However, it has also been found that, if the proportion of multi-layered particles formed by mechanical alloying process excessively increases, the toughness of the aluminum alloy material decreases.

In this regard, with the above method (5), by performing mechanical alloying process so that the number of multi-layered particles is 70% or more of the number of particles of the powdered supersaturated solid solution subjected to mechanical alloying process, it is possible to improve the strength of the aluminum alloy material. Further, with the above method (5), by performing mechanical alloying process so that the number of multi-layered particles is 90% or less of the number of particles of the powdered supersaturated solid solution subjected to mechanical alloying process, it is possible to suppress a reduction in toughness of the aluminum alloy material.

(6) A basket for a cask according to at least one embodiment of the present invention is formed of the aluminum alloy material described in any one of the above (1) to (5).

With the above configuration (6), the basket for a cask is formed of the above aluminum alloy material (1), which has improved strength characteristics since more manganese than usual is precipitated in aluminum as fine particles of Al₆Mn. Thus, it is possible to obtain a basket for a cask with improved strength characteristics.

(7) A cask according to at least one embodiment of the present invention comprises: the basket described in the above (6); a main body accommodating the basket; and a lid portion for closing an end opening of the main body.

With the above configuration (7), the basket for a cask is formed of the above aluminum alloy material (1), which has improved strength characteristics since more manganese than usual is precipitated in aluminum as fine particles of Al₆Mn. Thus, it is possible to obtain a basket for a cask with improved strength characteristics.

According to at least one embodiment of the present invention, there is provided an aluminum alloy material with improved strength characteristics.

### BRIEF DESCRIPTION OF DRAWINGS

FIG. 1 is a flowchart of a method for producing an aluminum alloy material according to some embodiments.

FIG. 2 is a diagram showing a part of the aluminum side of an Al—Mn binary phase diagram.

FIG. 3 is a flowchart of a method for producing an aluminum alloy material using an atomization method.

FIG. 4 is a table showing the composition of raw materials of prototype.

FIG. 5 is a diagram showing an average value of 0.2% proof stress at room temperature of samples produced from commercially available aluminum alloy A3004 and prototype.

FIG. 6 is a graph showing how tensile strength changes in a temperature environment of 200 C.° before and after annealing, as for samples produced from commercially available aluminum alloy A3004 and prototype.

FIG. 7 is a flowchart of a method for producing an aluminum alloy material in a case where mechanical alloying process is performed.

FIG. 8 is a schematic diagram for describing multilayer formation rate.

FIG. 9 is a graph showing a relationship between multilayer formation rate and 0.2% proof stress of samples of supersaturated solid solution subjected to mechanical alloying process.

FIG. 10 is a graph showing a relationship between multilayer formation rate and lateral expansion, as measured by Charpy impact test, of samples of supersaturated solid solution subjected to mechanical alloying process.

FIG. 11 is a configuration diagram of a cask according to an embodiment.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”. “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

First, a configuration of an aluminum alloy material according to some embodiments will be described.

An aluminum alloy material according to some embodiments is based on aluminum and contains 2.5 mass % or more and 4.0 mass % or less of manganese and 0.01 mass % or more and 0.12 mass % or less of zirconium.

In the aluminum alloy, manganese is a metallic element which contributes to precipitation strengthening. That is, manganese is precipitated as an Al—Mn compound and forms precipitates, thereby improving strength characteristics of the aluminum alloy material.

The aluminum alloy material according to some embodiments contains 2.5 mass % or more and 4.0 mass % or less of manganese.

That is, the aluminum alloy according to some embodiments contains the maximum solubility limit (1.82 mass % at 658.5° C. (eutectic temperature)) or more of manganese.

The aluminum alloy containing manganese in an amount of more than 1.82 mass %, which is the maximum solubility limit, forms a eutectic structure of aluminum (Al) and Al₆Mn at the eutectic temperature or lower. This eutectic structure has a layered structure and does not substantially contribute to improvement in strength characteristics. Accordingly, it is generally considered that it is difficult to achieve the strength characteristic improvement effect from the aluminum alloy containing more than the maximum solubility limit of manganese.

In this regard, as described later, by rapidly cooling a melt of the aluminum alloy containing more than the maximum solubility limit of manganese, it is possible to obtain a supersaturated solid solution in which the manganese enters into solid solution in aluminum in a supersaturated manner. Further, by subjecting the supersaturated solid solution to heat treatment, it is possible to precipitate Mn-based dispersed phase, specifically, fine particles of Al₆Mn or the like. Consequently, more manganese can be precipitated as fine particles of Al₆Mn or the like in aluminum than usual. Thus, it is possible to obtain the aluminum alloy material with improved strength characteristics.

As described later, the present inventor has intensively studied and consequently found that, when the content of manganese is 2.5 mass % or more, even if the aluminum alloy is annealed, the tensile strength in a temperature environment of 200° C. does not decrease compared to before annealing. In particular, it has been found that, when the content of manganese is more than 3.0 mass %, the tensile strength of the annealed aluminum alloy in a temperature environment of 200° C. clearly improves compared to before annealing.

Thus, when the addition amount of manganese in the aluminum alloy is 2.5 mass % or more, it is possible to suppress a reduction in tensile strength in a temperature environment higher than room temperature after annealing. Further, when the addition amount of manganese in the aluminum alloy is more than 3.0 mass %, it is possible to improve the tensile strength in a temperature environment higher than room temperature after annealing.

The aluminum alloy material according to some embodiments further contains 0.01 mass % or more and 0.12 mass % or less of zirconium.

Thereby, since the zirconium prevents generation of coarse particles in the aluminum alloy, it is possible to prevent a reduction in strength of the aluminum alloy.

The aluminum alloy material according to some embodiments may further contain 0.55 mass % or more and 0.60 mass % or less of iron.

Thereby, it is possible to precipitate fine particles of Al₆Mn or the like in solid Al using Fe as precipitate nuclei at the eutectic temperature or lower in the aluminum alloy containing more than the maximum solubility limit of manganese. Consequently, more manganese can be precipitated as fine particles of Al₆Mn or the like in aluminum than usual. Thus, it is possible to obtain the aluminum alloy material containing manganese in an amount equal to or more than the maximum solubility limit, with improved strength characteristics.

In particular, as described above, when the content of Fe is 0.55 mass % or more, it is possible to sufficiently precipitate the manganese as an Al—Mn compound using Fe as precipitate nuclei in the aluminum alloy. Further, when the content of Fe is 0.60 mass % or less, it is possible to suppress embrittlement of the aluminum alloy material.

The aluminum alloy material according to some embodiments may further contain 0.06 mass % or more and 0.10 mass % or less of silicon.

Thereby, it is possible to precipitate fine particles of Al₆Mn in solid Al using Si as precipitate nuclei at the eutectic temperature or lower in the aluminum alloy containing more than the maximum solubility limit of manganese. Consequently, more manganese can be precipitated as micro particles of Al₆Mn in aluminum than usual. Thus, it is possible to obtain the aluminum alloy material with improved strength characteristics.

In particular, as described above, when the content of Si is 0.06 mass % or more, it is possible to sufficiently precipitate the manganese as an Al—Mn compound using Si as precipitate nuclei in the aluminum alloy. Further, when the content of Si is 0.10 mass % or less, it is possible to suppress embrittlement of the aluminum alloy material.

The aluminum alloy material according to some embodiments may further contain 0.8 mass % or more and 1.3 mass % or less of magnesium.

Thereby, the magnesium enters into solid solution in aluminum in the aluminum alloy, and it is possible to improve the strength of the aluminum alloy.

In some embodiments, in the aluminum alloy material, at least a part of Mn is contained as a non-equilibrium precipitate of Al₆Mn or the like.

The non-equilibrium precipitate of Al₆Mn or the like contributes to improvement in strength characteristics in the aluminum alloy material. Thus, strength characteristics of the aluminum alloy material are improved when at least a part of Mn is contained as the non-equilibrium precipitate of Al₆Mn or the like.

In some embodiments, the non-equilibrium precipitate of Al₆Mn or the like is granular precipitates.

When the non-equilibrium precipitate of Al₆Mn contained in the aluminum alloy material is granular precipitates, strength characteristics of the aluminum alloy material are improved compared with a case where a layered eutectic structure is formed.

(Method for Producing Aluminum Alloy Material)

Next, a method for producing an aluminum alloy material according to some embodiments will be described.

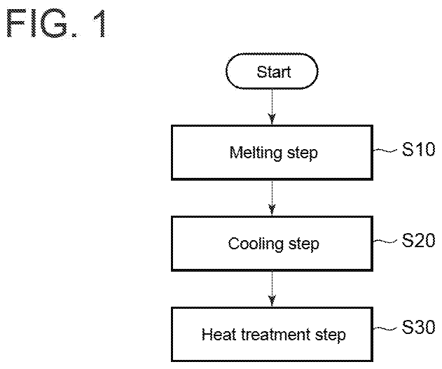

FIG. 1 is a flowchart of a method for producing an aluminum alloy material according to some embodiments. As shown in FIG. 1, the method for producing an aluminum alloy material according to some embodiments includes a melting step S10, a cooling step S20, and a heat treatment step S30.

(Melting Step S10)

The method for producing an aluminum alloy material according to some embodiments starts with, in the melting step S10, melting an aluminum alloy based on aluminum (Al) and containing more than 3.0 mass % and 4.0 mass % or less of manganese (Mn) to obtain a melt of the aluminum alloy. An aluminum alloy based on aluminum (Al) and containing 2.5 mass % or more and 4.0 mass % or less of manganese (Mn) may be melt to obtain a melt of the aluminum alloy. The melt may contain, in addition to manganese, elements such as zirconium, iron, silicon, and magnesium within the above-described range of content.

(Cooling Step S20)

Then, in the cooling step S20, the melt of the aluminum alloy obtained in the melting step S10 is appropriately cooled so that the manganese enters into solid solution in the aluminum in a supersaturated manner to obtain a supersaturated solid solution without forming a eutectic structure of aluminum (Al) and Al₆Mn.

For instance, the melt of the aluminum alloy is relatively rapidly cooled to obtain a supersaturated solid solution in which the manganese enters into solid solution in the aluminum in a supersaturated manner.

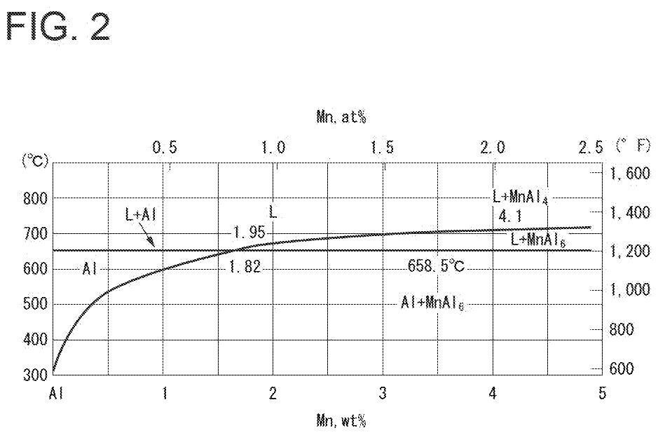

FIG. 2 is a diagram showing a part of the aluminum side of an Al—Mn binary phase diagram.

When the melt of the aluminum alloy containing more than the maximum solubility limit of manganese is relatively slowly cooled so that the equilibrium state is maintained, a eutectic structure of aluminum (Al) and Al₆Mn is formed, as described below.

That is, as shown in FIG. 2, in a region where the Mn content is more than 1.82 mass % which is the maximum solubility limit, the aluminum alloy at a temperature higher than 658.5° C. which is the eutectic temperature is in a state where liquid and an Al—Mn compound coexist (region indicated by “L+MnAl₆” in FIG. 2). Accordingly, when the molten aluminum alloy containing more than 1.82 mass % (the maximum solubility limit) of manganese is relatively slowly cooled, in the course of cooling, a eutectic structure of Al and Al₆Mn is formed rather than Al₆Mn is precipitated as small precipitates, through the region where liquid and an Al—Mn compound coexist (region indicated by “L+MnAl₆”) on the phase diagram because the diffusion rate of manganese is relatively high in a liquid phase.

If the eutectic structure is formed in the aluminum alloy, it is difficult to achieve the strength characteristic improvement effect in the aluminum alloy material.

By contrast, in the cooling step according to the above embodiment, for instance, the melt of the aluminum alloy is relatively rapidly cooled. This enables formation of a supersaturated solid solution in which the maximum solubility limit or more of manganese enters into solid solution in an aluminum parent phase. Thus, in a subsequent heat treatment step, the manganese in the supersaturated solid solution can be precipitated as fine particles of Al₆Mn in solid Al. Consequently, more manganese can be precipitated as fine particles in the aluminum than usual. Thus, it is possible to obtain the aluminum alloy material with improved strength characteristics.

In some embodiments, the cooling step S20 includes supplying the melt of the manganese-containing aluminum alloy with a gas to cool and atomize the melt. That is, in an embodiment, the melt of the manganese-containing aluminum alloy is made into powder by an atomization method to obtain a powdered supersaturated solid solution.

In this case, since the melt of the manganese-containing aluminum alloy is atomized and rapidly cooled simultaneously by supplying the melt with a high-pressure gas, it is possible to form the supersaturated solid solution in which the manganese enters into solid solution in the aluminum parent phase in a supersaturated manner.

The powder of the supersaturated solid solution obtained by atomizing the melt of the aluminum alloy by the atomization method may have an average particle size of 5 μm or more and 80 μm or less.

When the powder obtained by supplying the melt of the aluminum alloy with a high-pressure gas has an average particle size of 5 μm or more, the powder can be easily formed by supplying the melt with the gas. When the powder has an average particle size of 80 μm or less, its specific surface area is relatively large, and the melt can be easily rapidly cooled when atomized. Thus, the supersaturated solid solution can be easily formed.

Further, the powder of the supersaturated solid solution obtained by atomizing the melt of the aluminum alloy by the atomization method may have a median particle size D50 of 50 μm or less.

In an embodiment, the cooling step includes forming a molding of the supersaturated solid solution by a DC casting method (Direct Chill Casting).

In the DC casting method, a molding is obtained while a molten metal is directly cooled with a coolant. That is, when the DC casting method is adopted in the cooling step, the molding is obtained while the melt of the aluminum alloy is directly cooled with a coolant (e.g., water), so that the melt is rapidly cooled. Thus, it is possible to obtain the molding of the supersaturated solid solution in which the manganese enters into solid solution in the aluminum parent phase in a supersaturated manner.

(Heat Treatment Step S30)

In the heat treatment step S30, the supersaturated solid solution obtained in the cooling step S20 is subjected to heat treatment to precipitate at least a part of the manganese dissolved in the aluminum in the supersaturated solid solution as Al₆Mn or the like. In some embodiments, the heat treatment step S30 includes heating and keeping the supersaturated solid solution within a temperature range of 300° C. or higher and 620° C. or lower in a vacuum sintering furnace.

As described above, when the supersaturated solid solution is heated and kept at 300° C. or higher, it is possible to easily precipitate fine particles of Al₆Mn or the like. Further, as described above, when the supersaturated solid solution is heated and kept at 620° C. or lower, it is possible to easily precipitate homogeneous particles of Al₆Mn or the like.

Thus, by heating and keeping within the above temperature range, it is possible to effectively precipitate particles of Al₆Mn or the like, which contribute to improvement in strength characteristics of the aluminum alloy.

In a case where a metallic material for use in a basket for a cask described later is manufactured, before the heat treatment step S30, powder of a neutron absorbing material (e.g., B₄C) may be mixed to the powdered supersaturated solid solution, for instance. In this case, it is possible to impart the neutron absorbing function to the resulting metallic material.

As described above, in some embodiments, by performing the melting step S10 and the cooling step S20, it is possible to obtain the supersaturated solid solution in which the manganese enters into solid solution in the aluminum in a supersaturated manner. Further, by performing the heat treatment step S30, it is possible to precipitate Mn-based dispersed phase, specifically, fine particles of Al₆Mn or the like. Consequently, more manganese can be precipitated as fine particles of Al₆Mn or the like in aluminum than usual. Thus, it is possible to obtain the aluminum alloy material with improved strength characteristics.

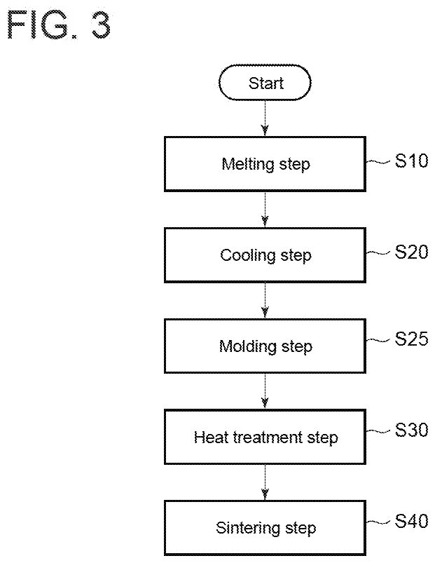

The entire method for producing an aluminum alloy material in a case where the atomization method is adopted in the cooling step S20 will now be described with the flowchart. FIG. 3 is a flowchart of the method for producing an aluminum alloy material using the atomization method.

Each step described below can also be applied in a case where a method other than the atomization method is adopted in the cooling step S20. For instance, a heat treatment step S30 and a sintering step S40 described below can be applied in a case where the cooling step is performed with the DC casting method.

In the embodiment shown in FIG. 3, first, a melting step S10 is performed. The melting step S10 in the embodiment shown in FIG. 3 is the same as the melting step S10 in FIG. 1 described above.

Then, in the embodiment shown in FIG. 3, a cooling step S20 is performed. In the cooling step S20 in the embodiment shown in FIG. 3, the melt of the manganese-containing aluminum alloy is made into powder by the atomization method to obtain a powdered supersaturated solid solution.

The powder of the supersaturated solid solution obtained in the cooling step S20 in the embodiment shown in FIG. 3 may have an average particle size of 5 μm or more and 80 μm or less.

When the powder obtained by supplying the melt of the aluminum alloy with a gas has an average particle size of 5 μm or more, the powder can be easily formed by supplying the melt with the gas. When the powder has an average particle size of 80 μm or less, its specific surface area is relatively large, and the melt can be easily rapidly cooled when atomized. Thus, the supersaturated solid solution can be easily formed.

The powder of the supersaturated solid solution obtained by the cooling step S20 in the embodiment shown in FIG. 3 may have a median particle size D50 of 50 μm or less.

In the embodiment shown in FIG. 3, after the cooling step S20, a molding step S25 is performed. In the molding step S25, the powdered supersaturated solid solution obtained in the cooling step S20 is molded by hydrostatic pressure molding, for instance, to obtain a molding.

In the embodiment shown in FIG. 3, after the molding step S25, a heat treatment step S30 is performed. The heat treatment step S30 in the embodiment shown in FIG. 3 is the same as the heat treatment step S30 in FIG. 1 described above, and the molding obtained in the molding step S25 is subjected to heat treatment.

The melting step S10 to the heat treatment step S30 described above allow fine particles of Al₆Mn to be precipitated in solid Al in the aluminum alloy containing more than the maximum solubility limit of manganese. Consequently, more manganese can be precipitated as fine particles in the aluminum than usual. Thus, it is possible to obtain the aluminum alloy material with improved strength characteristics.

In the embodiment shown in FIG. 3, the heat treatment step S30 is followed by a sintering step S40. In the sintering step S40, after heat treatment in the heat treatment step S30, the molding is heated and kept within a temperature range of 500° C. or higher and 620° C. or lower in a vacuum sintering furnace to sinter the molding.

The molding sintered in the sintering step S40 is extruded by hot extrusion to obtain an extruded material.

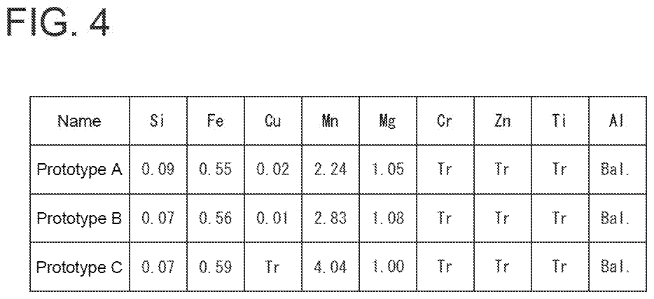

In the following, examples of characteristics of prototype of the aluminum alloy material obtained as above will be described. FIG. 4 is a table showing the composition of raw materials of the prototype. The values in the table show mass % of each element in the prototype. Chromium (Cr), zinc (Zn), titanium (Ti), and copper (Cu) in prototype C is incidental impurities. The remainder is aluminum (Al).

Prototypes A to C are different in manganese content. The prototype A contains 2.24 mass % of manganese, the prototype B contains 2.83 mass % of manganese, and the prototype C contains 4.04 mass % of manganese.

With respect to the prototypes A to C of the aluminum alloy material obtained as described above, multiple samples were formed from the aluminum alloy materials subjected to hot extrusion after the sintering step S40 in FIG. 3, and characteristics thereof were examined.

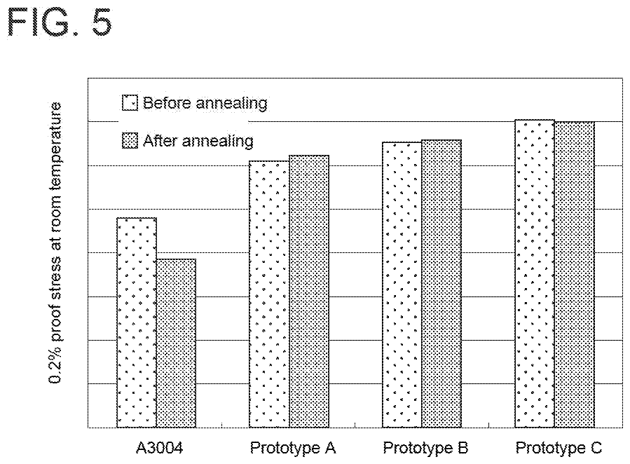

FIG. 5 is a diagram showing an average value of 0.2% proof stress at room temperature of samples produced from commercially available aluminum alloy A3004 and the prototypes A to C.

The target addition amount of manganese in the commercially available aluminum alloy A3004 is 1.0 mass % or more and 1.5 mass % or less.

For examination of 0.2% proof stress at room temperature, the sample before annealing and the sample after annealing were compared. The annealing condition is, for instance, keeping at 520° C., for 10 hours and then cooling at a predetermined cooling rate.

As shown in FIG. 5, the commercially available aluminum alloy A3004 decreased 0.2% proof stress at room temperature after annealing. By contrast, all of the prototypes A to C hardly decreased 0.2% proof stress at room temperature after annealing. Further, all of the prototypes A to C exhibited higher 0.2% proof stress at room temperature than the commercially available aluminum alloy A3004.

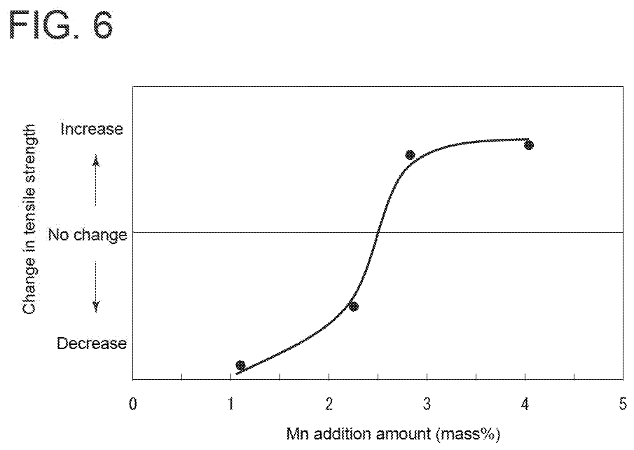

FIG. 6 is a graph showing how tensile strength changes in a temperature environment of 200 C.° before and after annealing, as for samples produced from the commercially available aluminum alloy A3004 and the prototypes A to C. In the graph of FIG. 6, the horizontal axis represents manganese content (addition amount) expressed by mass %, and the vertical axis represents the tensile strength in a temperature environment of 200 C.° after annealing compared to the tensile strength in a temperature environment of 200 C.° before annealing. In the vertical axis, the height position of the auxiliary line noted as “no change” is a point at which the tensile strength in a temperature environment of 200 C.° before annealing is equal to the tensile strength in a temperature environment of 200 C.° after annealing. A region below the auxiliary line is a region where the tensile strength in a temperature environment of 200 C.° after annealing is lower than the tensile strength before annealing A region above the auxiliary line is a region where the tensile strength in a temperature environment of 200 C.° after annealing is higher than the tensile strength before annealing.

As shown in FIG. 6, it has been found that, when the content of manganese is 2.5 mass % or more, even if the aluminum alloy is annealed, the tensile strength in a temperature environment of 200° C. does not decrease compared to before annealing. In particular, it has been found that, when the content of manganese is more than 3.0 mass %, the tensile strength of the annealed aluminum alloy in a temperature environment of 200° C. clearly improves compared to before annealing.

Thus, when the addition amount of manganese in the aluminum alloy is 2.5 mass % or more, it is possible to suppress a reduction in tensile strength in a temperature environment higher than room temperature after annealing. Further, when the addition amount of manganese in the aluminum alloy is more than 3.0 mass %, it is possible to improve the tensile strength in a temperature environment higher than room temperature after annealing.

(Regarding Mechanical Alloying)

In some embodiments, the powdered supersaturated solid solution obtained by the melting step S10 and the cooling step S20 is subjected to mechanical alloying process to further disperse the manganese in the solid solution. A case where mechanical alloying process is performed will now be described.

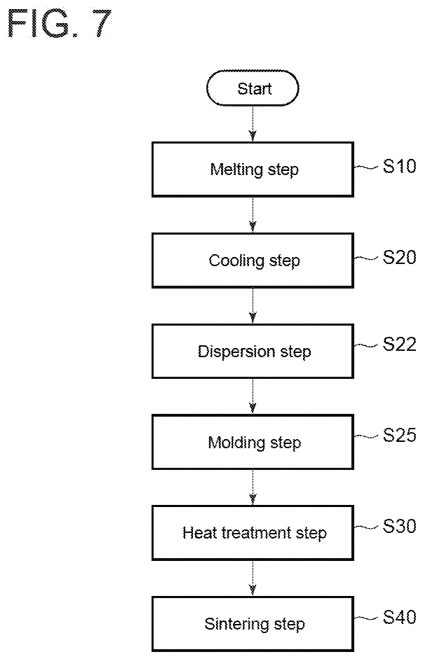

FIG. 7 is a flowchart of the method for producing an aluminum alloy material in a case where mechanical alloying process is performed.

In the embodiment shown in FIG. 7, a melting step S10 and a cooling step S20 are the same as the melting step S10 and the cooling step S20 in FIG. 3 described above. That is, in the embodiment shown in FIG. 7, in the cooling step S20, the melt of the manganese-containing aluminum alloy is made into powder by the atomization method to obtain a powdered supersaturated solid solution. As described above, the supersaturated solid solution may contain, in addition to manganese, elements such as zirconium, iron, silicon, and magnesium within the above-described range of content.

In the embodiment shown in FIG. 7, after the cooling step S20, a dispersion step S22 is performed. The dispersion step S22 is a step of performing mechanical alloying process on the powdered supersaturated solid solution obtained in the cooling step S20. In the dispersion step S22, the powdered supersaturated solid solution obtained in the cooling step S20 and balls of iron or zirconia or the like are put into a cylindrical processing chamber of a mechanical alloying device (not shown), and the powdered supersaturated solid solution and the balls are stirred by a stirring device of the mechanical alloying device. As a result, the powdered supersaturated solid solution is pressed between the balls stirred together upon collision between the balls and is flattened, crimped, and rolled repeatedly into powder having a layered structure. Thus, the powdered supersaturated solid solution is repeatedly crimped and rolled to form a layered structure, so that the dispersion of manganese in the supersaturated solid solution proceeds.

In the embodiment shown in FIG. 7, after the dispersion step S22, a molding step S25 is performed. The steps including and after the molding step S25 are the same as those in the embodiment shown in FIG. 3.

As described above, in the embodiment shown in FIG. 7, by performing mechanical alloying process on the powdered supersaturated solid solution obtained in the cooling step S20, it is possible to further disperse the manganese in the solid solution. Further, by performing heat treatment on the powdered supersaturated solid solution subjected to mechanical alloying process, it is possible to precipitate at least a part of the manganese dissolved in the aluminum in the supersaturated solid solution as more dispersed and finer Al₆Mn particles. Therefore, it is possible to obtain the aluminum alloy material with further improved strength characteristics, compared to the case where mechanical alloying process is not performed.

In the powdered supersaturated solid solution obtained in the cooling step S20, the manganese tends to segregate at grain boundaries. However, with the mechanical alloying process, the manganese segregation region is finely broken, and the manganese is dispersed well.

In mechanical alloying process in the dispersion step S22, as the processing time increases, the powdered supersaturated solid solution is repeatedly crimped and rolled, a particle of the powdered supersaturated solid solution forms more layers, and the manganese in the supersaturated solid solution is dispersed. As a result of intensive studies by the present inventor, it has been found that, as the proportion of multi-layered particles formed by mechanical alloying process increases in particles of the powdered supersaturated solid solution, the strength of the aluminum alloy material increases. However, it has also been found that, if the proportion of multi-layered particles formed by mechanical alloying process excessively increases, the toughness of the aluminum alloy material decreases.

Hereinafter, multilayer formation rate will be described. As described above, in mechanical alloying process, since the powdered supersaturated solid solution is repeatedly crimped and rolled, as the processing time increases, the number of particles having a layered structure (multi-layer structure) increases. Then, a value of the proportion of the number of particles having at least two layers to particles of the powdered supersaturated solid solution is defined as multilayer formation rate.

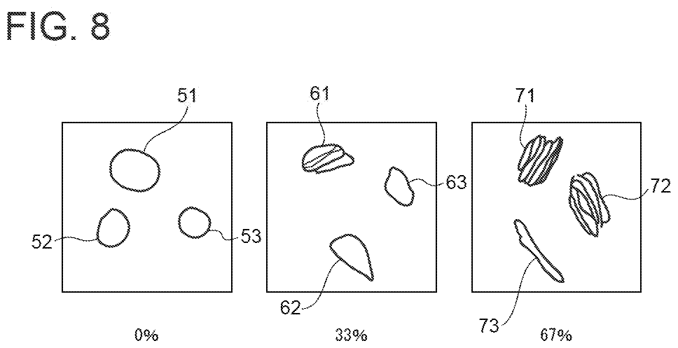

FIG. 8 is a schematic diagram for describing multilayer formation rate. For instance, in the left diagram of FIG. 8, since none of three particles 51 to 53 has a layered structure of two or more layers, multilayer formation rate is 0%. Further, for instance, in the middle diagram of FIG. 8, since one 61 of three particles 61 to 63 has a layered structure of two or more layers, multilayer formation rate is 33%. Further, for instance, in the right diagram of FIG. 8, since two 71, 72 of three particles 71 to 73 have a layered structure of two or more layers, multilayer formation rate is 67%.

Multilayer formation rate can be measured by the following method, for instance. For instance, a resin and particles of the supersaturated solid solution subjected to mechanical alloying process are mixed to form a sample of the mixture containing the resin and particles of the supersaturated solid solution for measuring multilayer formation rate. Then, the sample is cut, the cut surface is polished, and particles found on the cut surface are observed by a microscopy to obtain an image in which state of particles can be observed, as schematically shown in FIG. 8. In this image, it is possible to distinguish a multi-layered particle, i.e., a particle having a layered structure of two or more layers from a non-layered particle, i.e., a particle not having a layered structure of two or more layers.

By analyzing the image, the proportion of the number of particles having a layered structure of two or more layers is calculated, and thereby multilayer formation rate is determined. Assuming that “na” is the number of particles having a layered structure of two or more layer in the image, and “n” is the total number of particles in the image, multilayer formation rate is represented by the following expression (1):

Multilayer formation rate (%)=na/n×100 (1)

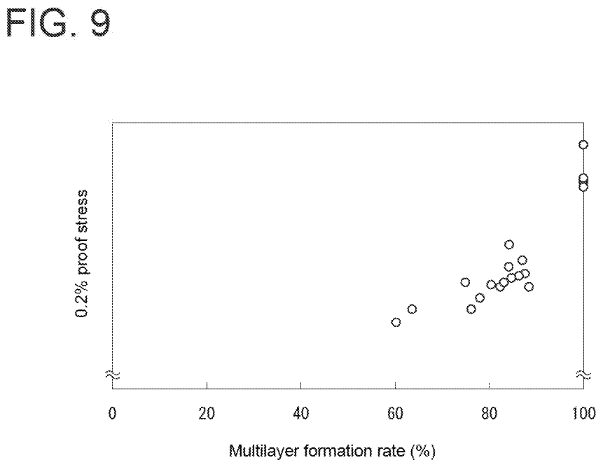

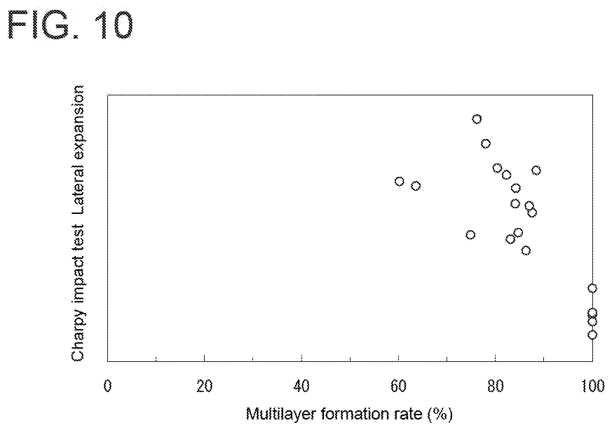

FIG. 9 is a graph showing a relationship, with respect to the supersaturated solid solution subjected to mechanical alloying process, between multilayer formation rate determined as described above and 0.2% proof stress at room temperature of samples produced from the supersaturated solid solution subjected to mechanical alloying process. FIG. 10 is a graph showing a relationship, with respect to the supersaturated solid solution subjected to mechanical alloying process, between multilayer formation rate determined as described above and lateral expansion, as measured by Charpy impact test, of samples produced from the supersaturated solid solution subjected to mechanical alloying process. In the graph shown in FIG. 10, the more the lateral expansion as measured by Charpy impact test, the higher the toughness.

As shown in the graph of FIG. 9, as multilayer formation rate increases, the value of 0.2% proof stress increases. However, as shown in the graph of FIG. 10, as multilayer formation rate increases, toughness decreases. Accordingly, to ensure 0.2% proof stress, multilayer formation rate is preferably 70% or more, more preferably 75% or more. Further, to suppress a reduction in toughness, multilayer formation rate is preferably 90% or less.

Then, in mechanical alloying process in the dispersion step S22, mechanical alloying process is performed so that 70% or more and 90% or less of the number of particles of the powdered supersaturated solid subjected to mechanical alloying process form multilayers, i.e., multilayer formation rate is 70% or more and 90% or less.

Thus, by performing mechanical alloying process so that the number of multi-layered particles is 70% or more of the number of particles of the powdered supersaturated solid solution subjected to mechanical alloying process, it is possible to improve the strength of the aluminum alloy material. Further, by performing mechanical alloying process so that the number of multi-layered particles is 90% or less of the number of particles of the powdered supersaturated solid solution subjected to mechanical alloying process, it is possible to suppress a reduction in toughness of the aluminum alloy material.

(Regarding Cask)

Next, a cask and a basket for a cask according to an embodiment will be described.

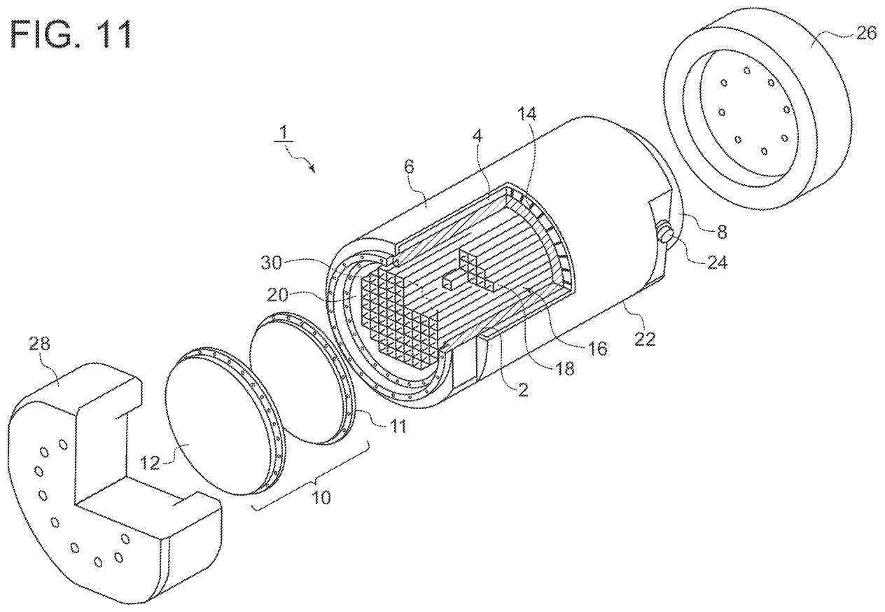

FIG. 11 is a configuration diagram of a cask according to an embodiment. The cask shown in FIG. 11 is a metal cask for transporting or storing a spent fuel.

As shown in FIG. 11, the cask 1 according to an embodiment includes a basket 16, a main body 2 for accommodating the basket 16, and a lid portion 10 for closing an end opening of the main body 2. The basket 16 is formed of the aluminum alloy material according to the above-described embodiments.

The cask 1 includes a resin 4, for shielding neutron, disposed around an outer periphery of the main body 2, an external cylinder 6 therearound, and a bottom portion 8. The main body 2 and the bottom portion 8 may be forging products made of carbon steel, which shields y rays. The lid portion 10 may include a primary lid 11 and a secondary lid 12. The primary lid 11 and the secondary lid 12 may be made of stainless steel. The main body 2 and the bottom portion 8 may be joined by butt welding. Although not illustrated, the structure may include a tertiary lid.

Trunnions 24 for suspending the cask 1 may be disposed on both sides of a cask body 22. In FIG. 11, one trunnion 24 is not depicted for clarity.

Further, shock absorbers 26, 28 in which a shock-absorbing member such as wood is encapsulated may be attached on both ends of the cask body 22.

A plurality of internal fins 14 for thermal conduction are disposed between the main body 2 and the external cylinder 6. The resin 4 is injected in a fluid state into a space formed by the internal fins 14 and then solidified by thermal curing or the like.

The basket 16 includes an assembly of bundled rectangular pipes 18 and is inserted into a cavity 20 of the main body 2. The rectangular pipes 18 may be formed of the aluminum alloy material according to the above-described embodiments. The aluminum alloy constituting the rectangular pipes 18 may contain a neutron absorbing member (boron: B) for absorbing neutrons from spent nuclear fuel. An individual storage space (cell) 30 formed by each of the rectangular pipes 18 may store a single spent fuel assembly.

The basket 16 or the rectangular pipes 18 may be manufactured by extrusion or other processing on the aluminum alloy material according to the above-described embodiments. The rectangular pipes 18 may be formed in a grid structure like box of cakes.

In the cask described above, the basket for the cask is formed by the aluminum alloy material according to the above-described embodiments; this aluminum alloy material has improved strength characteristics since more manganese than usual is precipitated in aluminum as fine particles of Al₆Mn. Thus, it is possible to form a basket with improved strength characteristics.

The present invention is not limited to the embodiments described above, but includes modifications to the embodiments described above, and embodiments composed of combinations of those embodiments.

For instance, although the metal cask for transporting or storing spent fuel was described as an example of use of the aluminum alloy material according to the above-described embodiments, the present invention is not limited thereto. For instance, the aluminum alloy material according to the above-described embodiments may be used to form a compressor wheel of a turbocharger or a compressor housing accommodating a compressor wheel or the like.

1. An aluminum alloy material based on aluminum, comprising:
2.5 mass % or more and 4.0 mass % or less of manganese;
0.01 mass % or more and 0.12 mass % or less of zirconium; and
0.55 mass % or more and 0.60 mass % or less of iron.

2. The aluminum alloy material according to claim 1, further comprising 0.06 mass % or more and 0.10 mass % or less of silicon.

3. The aluminum alloy material according to claim 1, further comprising 0.8 mass % or more and 1.3 mass % or less of magnesium.

4. A method for producing an aluminum alloy material, comprising:
a cooling step of supplying a melt of an aluminum alloy based on aluminum (Al) and containing 2.5 mass % or more and 4.0 mass % or less of manganese (Mn) with a high-pressure gas to cool and atomize the melt so that the manganese enters into solid solution in an aluminum parent phase in a supersaturated manner to obtain a powdered supersaturated solid solution;
a step of performing mechanical alloying process on the powdered supersaturated solid solution; and
a heat treatment step of performing heat treatment on the powdered supersaturated solid solution subjected to the mechanical alloying process to precipitate at least a part of the manganese as Al₆Mn and obtain an aluminum alloy material.

5. The method for producing an aluminum alloy material according to claim 4,
wherein, in the step of performing mechanical alloying process, the mechanical alloying process is performed so that 70% or more and 90% or less of the number of particles of the powdered supersaturated solid solution subjected to the mechanical alloying process form multilayers.

6. A basket for a cask, formed of the aluminum alloy material according to claim 1.

7. A cask comprising:
the basket according to claim 6;
a main body accommodating the basket; and
a lid portion for closing an end opening of the main body.
